(19) United States
(12) Patent Application Publication
(10) Pub. No.: US 2010/0014908 A1
(43) Pub. Date: Jan. 21, 2010

(54) Joint compound tool

(76) Inventors: Shawn O. Campbell, Auburn, GA (US); Horace S. Young, Buford, GA (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 12/219,243

(22) Filed: Jul. 18, 2008

(51) Int. Cl. B43K 5/02; B05C 17/00

(52) U.S. Cl. 401/146; 401/197

(57) ABSTRACT

A joint compound tool including a mixer, a hose, and an applicator. The mixer has a hopper and a beater positioned therein. The beater has a rotatable drive shaft that is journaled in the opposed ends of the hopper. A number of first support rods radiate outwardly from the drive shaft remote from the hopper outlet. A pair of intertwined, helical bands encircle the drive shaft and are affixed thereto by the first support rods. A number of second support rods radiate outwardly from the drive shaft adjacent the hopper outlet. A number of blades are secured to the second support rods. A motor is connected to the drive shaft for rotating the beater. A pump is connected to the hopper outlet for pressurizing joint compound received from the hopper. A hose connects the pump to a joint compound applicator having a valve assembly for controlling the flow of joint compound received from the hose and a roller assembly for applying joint compound to drywall.

### FIELD OF THE INVENTION

The present invention relates generally to coating implements with material supply and, more particularly, to such implements where material flows through a hollow roller.

### BACKGROUND OF THE INVENTION

Drywall is a manufactured building material used for constructing walls and ceilings within buildings. In commercial construction, the work of installing and finishing drywall is often split between: “hangers” who secure drywall sheets to wall studs or ceiling joists, “tapers” who conceal the joints between drywall sheets with joint tape, and “mudmen” who conceal the joint tape and any nailheads with several layers of joint compound which is often called “mud.” After applying the joint compound, it is allowed to air dry and then sanded smooth in preparation for painting.

Joint compound is a mixture of water, limestone, perlite, a polymer and clay. This combination of ingredients gives joint compound a creamy texture which allows it to be easily spread onto drywall surfaces. Joint compound is usually mixed with mixing paddle turned by a heavy-duty drill. Some people prefer to mix joint compound by hand using a potato-masher-type mixer with a long handle. If the joint compound is too thick after mixing, small amounts of water are mixed in until the joint compound can be applied to drywall.

Applying joint compound to drywall is a straightforward effort with a trowel, usually never taking more than three or four coats. In new construction, joint compound effectively eliminates all blemishes from the surface of the drywall. Joint compound can also be used to finish corner bead and trim as well as patch holes, bumps, tears, and other minor drywall damage.

Ready-mix joint compound is usually more forgiving than the traditional, “mix-it-yourself” form of joint compound. Ready-mix can be often used for as long of a period of time as needed, and does not dry up unless left unattended for the better part of a day. Mix-it-yourself joint compound is made by blending a powder with water with a handheld beater and usually lasts for one to two hours before drying. However, with either type of joint compound that may have started to dry, the addition of water can help the joint compound regain its soft texture.

Today, drywall is installed in an average house in a few days by a crew of experienced workers. Larger houses, and those where optimum finishes are desired, take more time. For an optimum finish, entire walls may be given “skim coats” or thin layers of joint compound to smooth their exposed surfaces. Applying joint compound, then, can be time-consuming and costly. Mudmen and their employers are constantly seeking new ways to reduce the time required to complete mudding efforts.

### SUMMARY OF THE INVENTION

In light of the problems associated with applying joint compound to drywall, it is a principal object of the invention to provide a tool that will: stir joint compound (whether ready-mix type or mix-it-yourself type) to a smooth consistency, deliver the stirred joint compound to a desired location on a wall or ceiling, and spread the joint compound at the desired location with minimal intervention on the part of a user. The tool, by its use, saves time, reduces waste, and virtually eliminates the mess normally associated with the blending joint compounds to a smooth consistency.

It is another object of the invention to provide a tool of the type described that can apply joint compound to a wall in any orientation, reducing stress on the bodies of users. Use of the tool is so easy that it can be operated with one hand.

It is a further object of the invention to provide a tool of the type described that is portable for easy transport from one work location to another. When not in use, the tool can be stored in a small, out-of-the-way space such as a closet.

Still another object of the invention is to provide a tool that is easily and quickly disassembled and cleaned after use.

It is an object of the invention to provide improved features and arrangements thereof in a joint compound tool for the purposes described which is lightweight in construction, inexpensive to manufacture, and dependable in use.

Briefly, the tool in accordance with this invention achieves the intended objects by featuring a mixer, a hose, and an applicator. The mixer has a hopper with a beater positioned therein. The beater has a rotatable drive shaft that is journaled in the opposed ends of the hopper. A number of first support rods radiate outwardly from the drive shaft remote from the hopper outlet. A pair of intertwined, helical bands encircle the drive shaft and are affixed thereto by the first support rods. A number of second support rods radiate outwardly from the drive shaft adjacent the hopper outlet. A number of blades are secured to the second support rods. A motor is connected to the drive shaft for rotating the beater. A pump is connected to the hopper outlet for pressurizing joint compound received from the hopper. A hose connects the pump to a joint compound applicator having a valve assembly for controlling the flow of joint compound received from the hose and a roller assembly for applying joint compound to drywall.

The foregoing and other objects, features, and advantages of the present invention will become readily apparent upon further review of the following detailed description of the joint compound tool as illustrated in the accompanying drawings.

### BRIEF DESCRIPTION OF THE DRAWINGS

The present invention may be more readily described with reference to the accompanying drawings, in which:

FIG. 1 is an exploded perspective view of a joint compound tool in accordance with the present invention.

FIG. 2 is a perspective view of the mixer of the joint compound tool with its lid in an elevated position.

FIG. 3 is a perspective view of the mixer of FIG. 2 with its lid being removed and portions being broken away to reveal details thereof.

FIG. 4 is a top view of the mixer with its lid being removed.

FIG. 5 is a rear view of the mixer with portions broken away to reveal details thereof.

FIG. 6 is a top view of the staff of the roller assembly of the joint compound tool.

FIG. 7 is a perspective view of the valve assembly of the joint compound tool.

FIG. 8 is a perspective view of the extension arm of the joint compound tool with portions broken away to reveal details thereof.

FIG. 9 is an exploded perspective view showing the positioning of the joint compound roller on the roller bearing and outer transverse leg of the joint compound tool with portions of the various features being broken away to reveal details thereof.

FIG. 10 is a cross-sectional view taken along line 10′-10′ of FIG. 1.

FIG. 11 is a cross-sectional view taken along line 11′-11′ of FIG. 1.

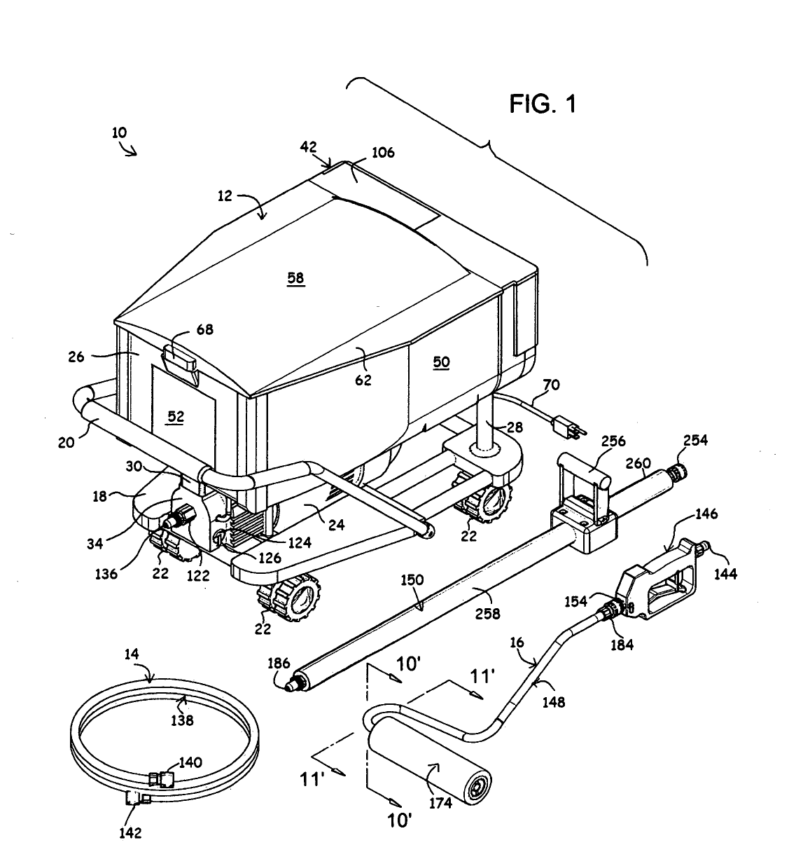

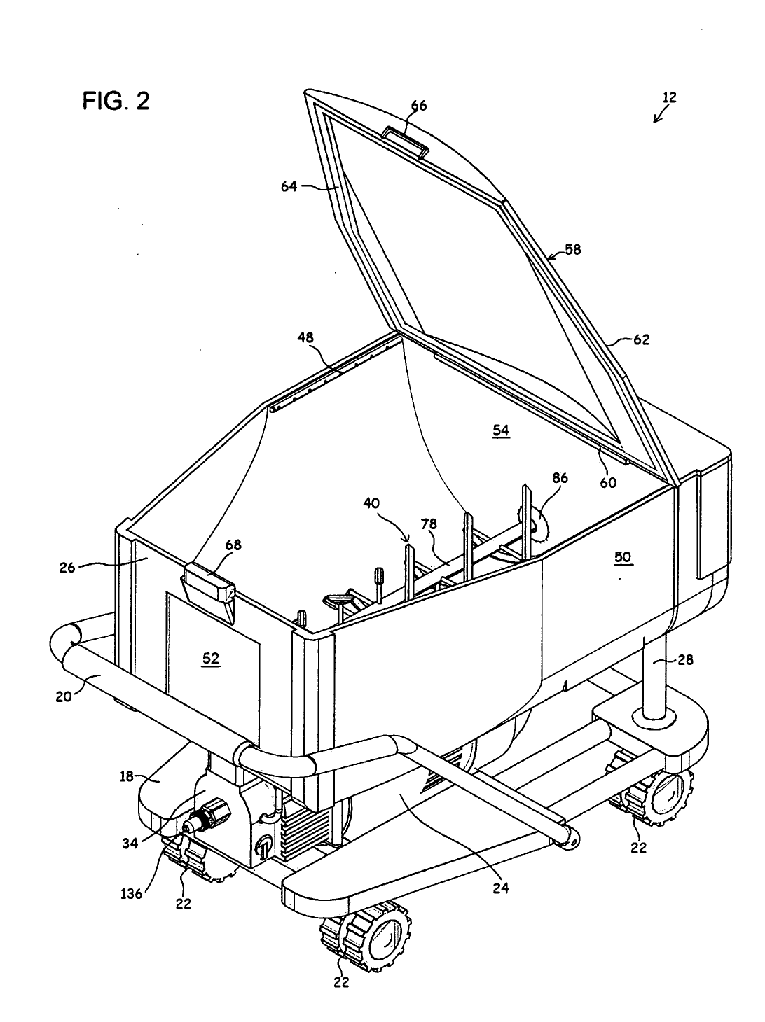

Similar reference characters denote corresponding features consistently throughout the accompanying drawings.

### DETAILED DESCRIPTION OF THE PREFERRED EMBODIMENT

Referring now to the FIGS., a joint compound tool in accordance with the present invention is shown at 10. Tool 10 includes a mixer 12 for producing joint compound of a smooth consistency. Connected to mixer 12 by means of a flexible hose 14 is an applicator 16 for evenly dispensing joint compound onto drywall.

Mixer 12 includes a rectangular frame 18 having a handlebar 20 extending upwardly therefrom. Frame 18 is supported for movement above the ground by four casters 22, one of which being disposed at each corner of frame 18. Affixed atop frame 18 is a joint compound pump 24 from which hose 14 extends to applicator 16. A hopper 26 is mounted atop pump 24 and is braced by a pair of support posts 28 that extend upwardly from frame 18. A short conduit 30 places the screened outlet 32 at the bottom of hopper 26 in fluid communication with the inlet 34 of pump 24. A heater 36 is affixed to the bottom of hopper 26 adjacent outlet 32. A motor 38 rotates a beater 40 positioned within hopper 26 above heater 36. A water tank 42 is affixed to hopper 26 adjacent motor 38. A water distribution hose 44 extends from a submersible, water pump 46 at the bottom of tank 42 to the top of hopper 26. Hose 44 terminates at a pair of spray nozzles 48, one on each side of hopper 26, for providing a supply of water to hopper 26.

Hopper 26 includes a channel wall 50 of U-shaped cross section. Channel wall 50 is capped at its front end by a front wall 52 and is capped at its rear end by a rear wall 54. Together, walls 50, 52 and 54 provide hopper 26 with an open top that is bounded by an upstanding peripheral edge or lip 56. Outlet 32 is provided in the bottom of channel wall 50 adjacent front wall 52.

A lid 58, attached at its rear end by means of a pair of hinges 60 to rear wall 54, selectively closes the open top of hopper 26. Lid 58 includes a cover plate 62 that is attached at its rear end by hinges 60 to rear wall 54. A seal 64 is secured around the periphery of cover plate 62 for engaging lip 56 so as to prevent air from entering hopper 26 which can dry joint compound therein and prevent joint compound from spilling from hopper 26. A catch 66 is provided at the front end of lid 58 for selectively engaging a latch 68 on front wall 52 and holding lid 58 tightly down on hopper 26.

Heater 36 is an electrical resistance-heating element that is secured to channel wall 50. Heater 36 is energized by selectively connected it through a cable 70 to an electrical current source such as a wall outlet (not shown). When connected to a current source, heater 36 emits sufficient heat to warm joint compound within hopper 26 to reduce the viscosity of the joint compound and prolong its curing time.

The maximum heat output of heater 36 is a matter of design choice. High heat output, capable of warming large volumes of the joint compound in hopper 26, requires that heater 36 be more heavily constructed to handle greater electrical current loads. The use of tool 10 in colder climates may require greater heat outputs. Milder climates would require less heating ability.

A variable resistor 72 is connected to cable 70 between the electrical current source and heater 36 for controlling the flow of current to heater 36 and, thereby, the heat output of heater 36. Resistor 72 is controlled by means of an associated knob 74 projecting from a control panel 76 affixed to the rear end of hopper 26. By rotating knob 74 in one direction the resistance to current flow to heater 36 is increased to infinity thereby deenergizing heater 36. By rotating knob 74 in the other direction, the resistance to current flow is minimized thereby causing heater 36 to deliver its maximum heat output. Between the two limits of knob rotation, the electrical current delivery to heater 36 is finely varied.

Beater 40 has a rotating drive shaft 78 that carries a pair of intertwined, helical bands 80 and number of paddles 82 for mixing joint compound. Drive shaft 78 is supported at its front end by a sealed journal bearing 84 mounted in front wall 52 and is supported at its rear end by a sealed journal bearing 86 mounted in rear wall 54. Drive shaft 78 extends through bearing 86 and connects to motor 38 such that, when motor 38 is energized, drive shaft 78 is rotated.

Helical bands 80 are located along the rear half of drive shaft 78 for breaking down any large lumps of material that may be present in joint compound. Each band 80 spirals about 1.25times around drive shaft 78 and has a stretched length that is about the same as that of drive shaft 78. Bands 80 are positioned in opposition to one another, 180° apart, at any position along the length of drive shaft 78.

Bands 80 are connected to shaft 78 by paired support rods 88. As shown, support rods 88 extend radially outward from drive shaft 78 at fixed intervals and in opposition to one another to meet bands 80 at their outer, free ends. Support rods 88 have similar lengths that ensure that bands 80 will not contact either channel wall 50 or lid 58 when beater 40 is rotated.

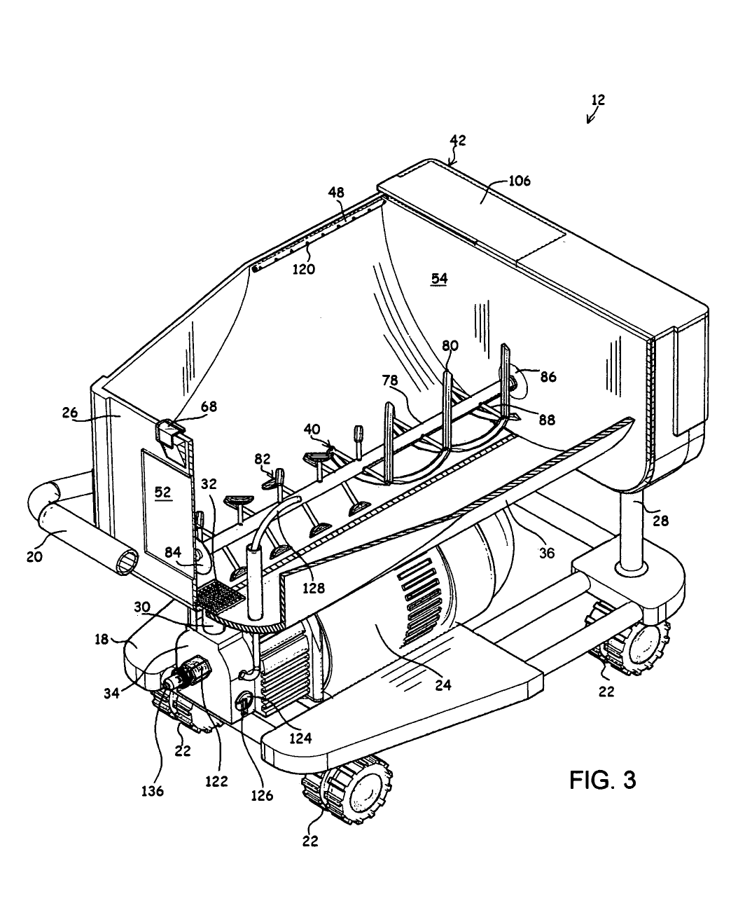

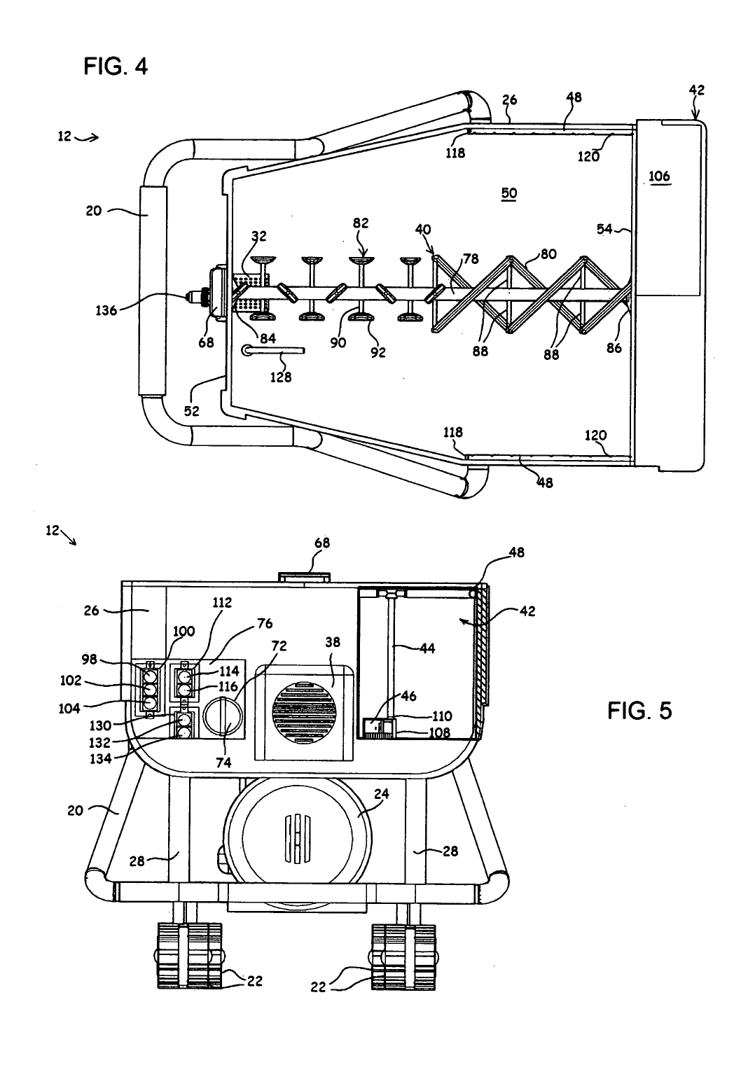

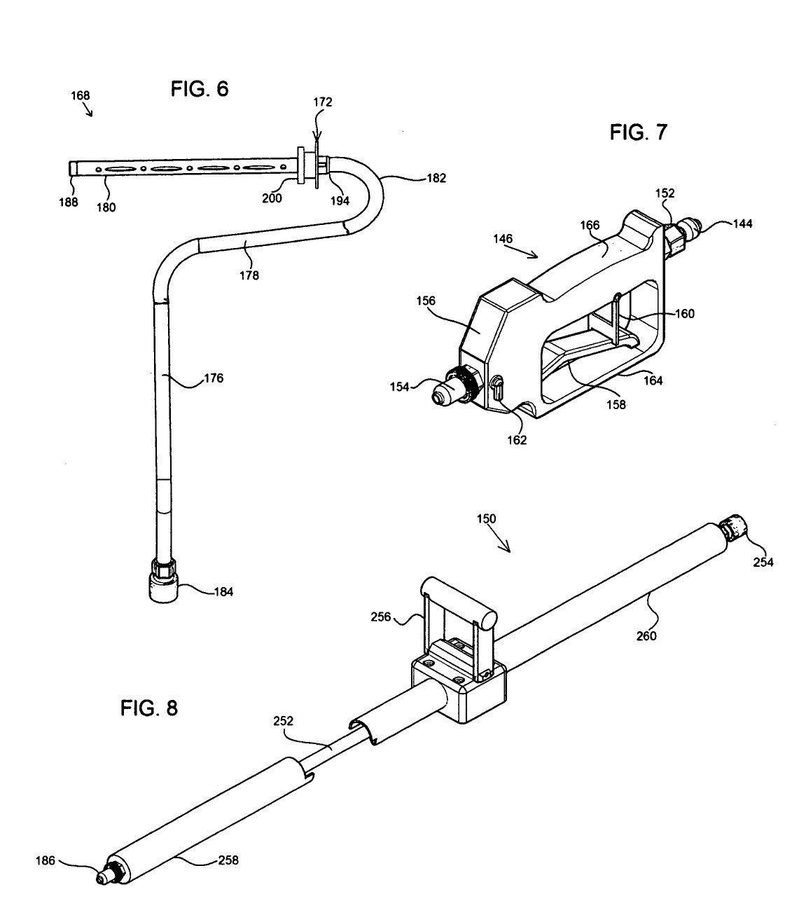

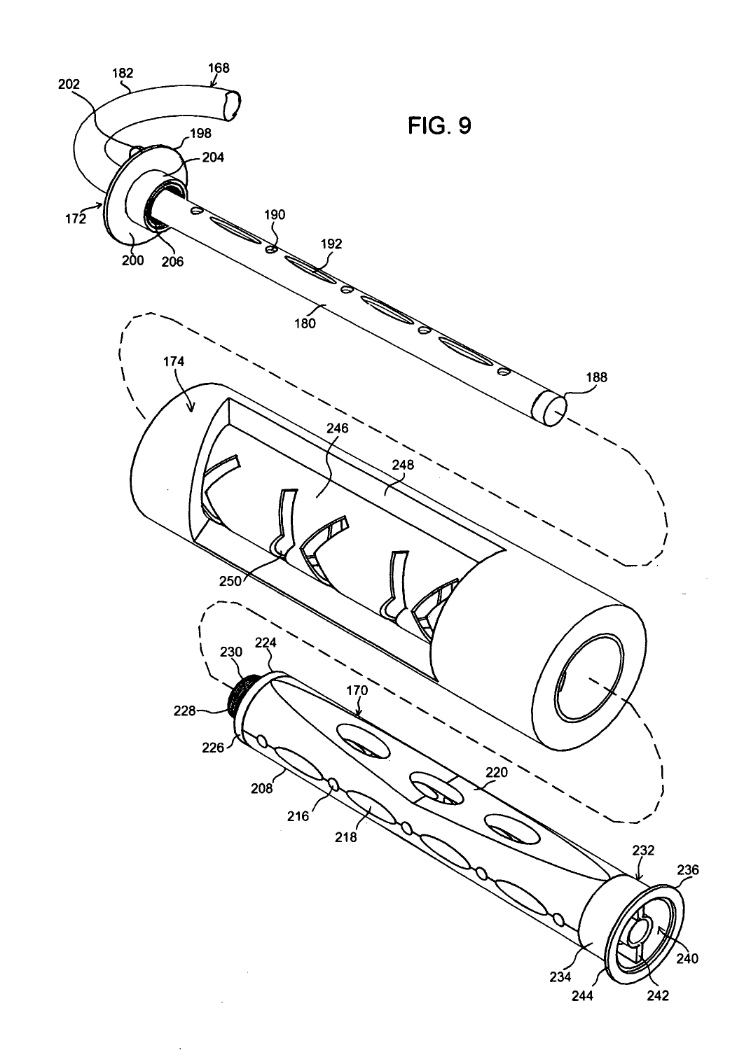

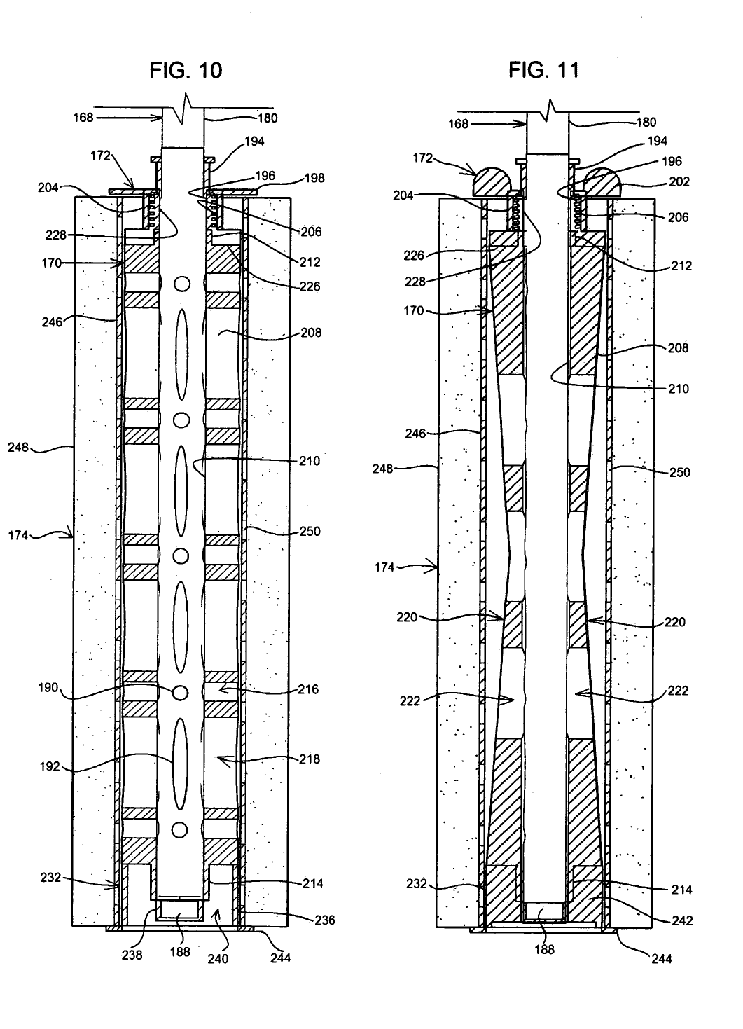

Paddles 82 are located along the front half of drive shaft 78 proximate outlet 32. To facilitate even mixing, paddles 82 are aligned in three rows oriented 120° apart. Said rows are best shown in FIGS. 3 and 4 to be located at angular positions of 12 o'clock, 4 o'clock, and 8 o'clock.

Each paddle 82 has a support rod 90 that projects radially outward from drive shaft 78. Affixed to the outer, free end of each rod 90 is a semicircular blade 92. As shown, each blade 92 is oriented at an angle of 45° to the longitudinal axis of drive shaft 78 with adjacent blades 92 being oriented at an angle, of 90° to one another. Blades 92 being smaller in size than helical bands 80, mix joint compound less aggressively than helical bands 80. Less aggressive mixing produces fewer and smaller bubbles in joint compound thereby providing a substantially bubble-free joint compound to outlet 32 and ultimately to drywall.

Motor 38 is capable of rotating beater 40 at either slow or fast speeds. To this end, a pair of resistors is provided for connecting motor 38 to current source through cable 70. A first resistor has a relatively high resistance for operating motor 38 at a relatively slow speed whereas a second resistor has a low resistance for operating motor 38 at a high speed. Pressing a pushbutton 98 of a 3-position toggle switch 100 on control panel 76 operatively connects motor 38 to the current source through the first resistor and pressing a pushbutton 102 of switch 100 operatively connects motor 38 to the current source through the second resistor. By pressing a third pushbutton 104 of switch 100, motor 38 is disengaged from the current source by toggling either of pushbuttons 98 or 102 to their original, “off“ positions.

Water tank 42 is connected to, and suspended from, rear wall 54. Tank 42 has an open top that is selectively closed by means of a sealing lid 106 that prevents losses due to spills and evaporation. The capacity of tank 42 is a matter of design choice, but must be sufficient to provide adequate dilution and thinning of joint compound in hopper 26.

Submersible pump 46 is positioned at the bottom of water tank 42. Pump 46 has an inlet 108 for receiving water held within tank 42. Pump 46 also has an outlet 110 that is connected to hose 44 which is bifurcated so as to terminate at a pair of spray nozzles 48 disposed within hopper 26. When pump 46 is energized, water is received through inlet 108, pressurized, and driven from outlet 110 into hose 44 where such is dispensed through nozzles 48.

Submersible pump 46 is connected via cable 70 to an electrical current source. A 2-position toggle switch 112 is employed to control the operation of pump 46. By pressing one pushbutton 114 associated with switch 112, pump 46 is energized by connecting it to an electrical current source via cable 70. Alternatively, by pressing a second pushbutton 116 associated with switch 112, pump 46 is deenergized and disconnected from the electrical current source.

Spray nozzles 48, that receive water from pump 46, are mounted on channel wall 50 and extend forwardly from rear wall 54 along opposite sides of hopper 26. Each of nozzles 48 comprises a hollow tube that is connected at its rear end to hose 44 and that is provided with a cap 118 at its front end. Each nozzle has a length that is about one-half that of hopper 26 and is provided with a number of spaced-apart orifices 120 for dispensing water into hopper 26. It should be noted that the positioning of nozzles 48 near the bands 80 of beater 40 and remote from outlet 32 ensures that water is well mixed into joint compound prior to the resulting mix leaving the hopper 26.

Pump 24 has an inlet 34 that receives joint compound from hopper 26. When operating, pump 24 draws joint compound from hopper 26 and delivers it under pressure through its outlet 122 to hose 14 and applicator 16. To make pump 24 operational, pump 24 must be primed with clean joint compound.

Priming pump 24 involves the opening of a joint compound diversion valve 124 on pump outlet 122 by manually turning a valve switch 126. When valve 124 is opened, joint compound is selectively diverted from outlet 122 and returned to hopper 26 through a return conduit 128 that enters hopper 26 adjacent outlet 32. After a sufficient period of time, valve 124 is manually closed by moving switch 126 to a second position so as to direct the flow of pressurized joint compound from outlet 122.

Joint compound pump 24 is connected via cable 70 to the electrical current source. As with submersible pump 46, a 2-position toggle switch 130 is employed to control the operation of pump 24. By pressing one pushbutton 132 associated with switch 130, pump 24 is energized by connecting it to an electrical current source via cable 70. By pressing a second pushbutton 134 associated with switch 130, pump 24 is deenergized and disconnected from the electrical current source. Pump 24 must, of course, be energized to conduct normal pumping and priming functions.

A check valve (not shown) on outlet 122 prevents joint compound from inadvertently draining from hopper 26 regardless of the position of switch 126 and requires that the joint compound be pressurized by pump 24 before the joint compound can pass through the check valve. Joint compound is forced through the check valve and into hose 14. A male hose connector 136 connected to the check valve facilitates the connection to hose 14.

Control panel 76 is positioned at the rear end of tool 10 adjacent water tank 42. Panel 76 is provided for the convenience of the user of tool 10 and provides a mount for the switches used to control the electrical components of tool 10. Thus, in one place, a user can find the primary controls for: joint compound pump 24, heater 36, beater motor 38, and water pump 46.

Flexible hose 14 provides the link between mixer 12 and applicator 16. Hose 14 includes a rubber tube 138 of any desired length. Female hose connectors 140 and 142, capable of mating with connector 136 and a male hose connector 144 on applicator 16, are secured to the opposite ends of tube 136 to facilitate the connection of hose 14 to other parts of tool 10.

Applicator 16 has three principal parts: a valve assembly 146, a roller assembly 148, and an auxiliary, extension arm 150 that connects valve assembly 146 to roller assembly 148. The use of extension arm 150 increases the length of applicator 16 and permits the user to apply joint compound to high walls and otherwise out-of-reach places. If desired, extension arm 150 need not be used with the balance of tool 10 and roller assembly 148 can be connected directly to valve assembly 146.

Valve assembly 146 includes a conduit 152 having male hose connectors 144 and 154 respectively affixed to its inlet and outlet ends. A manually operated valve 156 is connected to conduit 152 so as to control the flow of joint compound through conduit 152. Valve 156 is opened by pulling a control lever 158 extending from valve 156 toward conduit 152. Valve 156, however, is closed by a compressed spring (not shown) that returns control lever 158 to a position remote from conduit 152 when the pulling force imparted by a user is released. To maintain valve 156 in a closed position, a stop bracket 160 that is pivotally attached to conduit 152 is swung outwardly from conduit 152 to prevent control lever 158 from being moved toward conduit 152 from its valve-closing position.

The degree to which valve 156 can be opened can be adjusted separately from lever 158. To this end, valve 156 is provided with an internal stop that is adjusted by rotating a key 162 that projects from the side of valve 156. The rotation of key 162 to a first position allows full flow through valve 156 whereas the rotation of key 162 to a second position restricts flow substantially.

Valve assembly 146 is constructed for user comfort. A U-shaped finger guard 164 keeps the fingers of a user from slipping from lever 158 and has one of its ends secured to one end of conduit 152 and the other of its ends secured to the other end of conduit 152. A rubber hood 166 covers conduit 152, valve 156, and guard 164 to allow assembly 146 to be held for extended periods without injury.

Roller assembly 148 includes a staff 168 for conveying pressurized joint compound from its inner end to its outer end and for connecting, at its inner end, to either valve assembly 146 or extension arm 150. A roller bearing 170 is secured to the outer end of staff 168 by a bearing retainer 172. A roller 174 is fitted upon bearing 170 for dispensing joint compound to drywall.

Staff 168 is a hollow, rigid tube that is bent or otherwise formed with a base leg 176 and an inner transverse leg 178 joined at right angles to one another. An outer transverse leg 180 is joined to the free end of inner transverse leg 178 by a C-shaped crook 182. As shown, legs 178 and 180 are substantially parallel to one another and are coplanar with leg 176 and crook 182. A female hose connector 184 is secured to the free end of base leg 176 for connection to either of male hose connector 154 or a male hose connector 186 on extension arm 150. A cap 188 is affixed to the free end of outer transverse leg 180 to prevent the flow of joint compound therefrom. A number of slots 190 and 192 that alternate, respectively, in terms of length between short and long, is provided along the length of outer transverse leg 180 for dispensing joint compound therefrom.

Bearing retainer 172 positioned on outer transverse leg 180 near its junction with crook 182. Retainer 172 includes a retaining collar 194 that encircles outer transverse leg 180 and is affixed thereto so as to form a seal impervious to the passage of joint compound. Collar 194 is provided with a circumferential groove 196 that snugly, yet rotatably, retains the shoulder plate 198 of a bearing stop 200. (The secure positioning of shoulder plate 198 in groove 196 also provides a good seal against the passage of joint compound.) A pair of tabs 202 projects from one side of shoulder plate 198 toward crook 182 and a socket member 204 extends from the other side of shoulder plate 198 toward cap 188. Socket member 204 encircles outer transverse leg 180 and is provided with internal, helical threads 206. Shoulder plate 198, tabs 202 and socket member 204 are integrally formed such that the rotation of shoulder plate 198 with the application of a light torque to tabs 202 rotates socket member 204.

Roller bearing 170 supports roller 174 and distributes joint compound to roller 174. Roller bearing 170 comprises a tube 208 having an inner bore 210 adapted to loosely receive outer transverse leg 180 therein. Tube 208 is provided with necked portions 212 and 214 of reduced outer diameter at its opposite ends.

A number of slots 216 and 218 that alternate, respectively, in terms of length between short and long, are provided along the top and bottom of tube 208 for the passage of joint compound from inner bore 210. A pair of shallow, V-shaped notches 220 is provided in opposite sides of tube 208 and extends the length of tube 208 providing such with an external “hourglass” configuration when viewed from above or below. A number of slots 222 penetrate the opposite sides of tube 208 and open into notches 220. The deeper, central portions of notches 220 provide less resistance to the flow of joint compound than the shallower, lateral portions thereby funneling greater flows of joint compound to the central portions.

A bearing retainer 224 is affixed to one end of tube 208 for locking roller bearing 170 onto outer transverse leg 180. Retainer 224 has a ring 226 that is fitted onto necked portion 212 and a tubular sleeve 228 that extends outwardly from ring 226 away from tube 208. Sleeve 228 is sized to loosely receive outer transverse leg 180 therein. Sleeve 228 is provided with external, helical threads 230 that are adapted for threaded engagement with threads 206 of socket member 204.

A bearing centralizer 232 is affixed to the end of tube 208 opposite bearing retainer 224. Centralizer has a ring 234 that is fitted onto necked portion 214. An outer tubular sleeve 236 extends outwardly from the periphery of ring 234 away from tube 208. An inner tubular sleeve 238 extends outwardly from ring 234 and snugly encircles the free end of outer transverse leg 180 and cap 188. As shown, an annular space 240 is provided between sleeves 236 and 238 and a pair of opposed tabs 242, oriented 180° apart, extends across annular space 240 so as to connect sleeves 236 and 238 together. A circumferential flange 244 is affixed to the outer, free end of sleeve 236 and serves as a stop for roller 174.

Roller 174 is employed to apply joint compound to dry wall. Roller 174 includes a tubular former 246 and a tubular sheath 248 fitted upon former 246. Former 246 is a rigid tube having an inner diameter for snugly, yet releasably, receiving roller bearing 170 therein. Former 246 has a length that is the substantially the same as that of roller bearing 170. Former 246 also has a plurality of openings 250 along the length thereof for the even passage of joint compound to tubular sheath 248 and the even distribution of joint compound to drywall. Sheath 248 is formed from a porous material that is permeable to the flow of joint compound such as open-celled foam rubber. The use of materials that are textured can provide roller 174 with the ability to create interesting patterns with joint compound on drywall during the use of tool 10.

Extension arm 150 includes a rigid conduit 252 through which joint compound can flow. Conduit 252 has a female hose connector 254 affixed to one of its ends and male hose connector 186 affixed to the other of its ends. A loop-type handle 256 is affixed to the middle of conduit 252 and projects outwardly therefrom. A first piece of resilient foam 258 encircles conduit 252 between connector 186 and handle 256. A second piece of resilient foam 260 encircles conduit 252 between connector 254 and handle 256. Foam pieces 258 and 260 serve as auxiliary handles for a user to grasp.

The use of joint compound tool 10 is straightforward and involves four principal steps. First, tool 10 is assembled. Second, joint compound is mixed in mixer 12. Next, joint compound is pumped into applicator 16. Finally, joint compound is dispensed onto drywall with applicator 16.

Tool 10 is easily assembled and set up for use. First, by pulling on handle 20, mixer 12 is rolled on casters 22 to a place where joint compound is to be applied to drywall. Then, hose 14 is connected to mixer 12 by mating connectors 136 and 140 together. Now, valve assembly 146 is connected to the free end of hose 14 by mating connectors 142 and 144 together. Next, (assuming that the use of auxiliary, extension arm 150 is required) extension arm 150 is connected to valve assembly 146 by mating connectors 154 and 254 together. Afterward, roller assembly 148 is connected to the free end of extension arm 150 by mating connectors 184 and 186 together. Finally, cable 70 is connected to an electrical current source like a conventional wall outlet.

All joint compounds, even the ready-mix kind, need to be stirred before use. Well-mixed joint compound possesses few bubbles and is easy to apply. Mixing ensures that the joint compound has consistent water content throughout for even drying. Unfortunately, over-mixed joint compound is full of air bubbles that pop and appear as indentations when dry. The only way to fix the problem is to discard the joint compound and replace it with some without bubbles. Fortunately, tool 10 makes over-mixing difficult to accomplish.

Joint compound is easily placed into mixer 12. First, lid 58 is raised by detaching catch 66 from latch 68 and pivoting cover plate 62 upwardly on hinges 60 to expose the open top of hopper 26. Next, a box of joint compound is opened in the usual manner and its contents are slowly poured into hopper 26. Now, motor 38 is energized to cause beater 40 to turn in hopper 26 at a slow speed by pressing pushbutton 98 on control panel 76. If the joint compound appears to be too thick after several minutes of mixing, water must be added to the joint compound by pressing pushbutton 114 which energized pump 46 to drive water from tank 42 to nozzles 48 and into hopper 26. When a sufficient volume of water (a cup or two) has passed from nozzles 48, pump 46 is deenergized by pressing pushbutton 116. The rotation of beater 40 is continued until the joint compound is smooth and lump free. When the joint compound in hopper 26 appears ready, motor 38 is deenergized by pressing pushbutton 104 and lid 58 is closed to prevent air from drying the joint compound.

Mix-it-yourself joint compound is easily prepared in mixer 12. First, a small volume of water is admitted into hopper 26 via nozzles 48 by temporarily energizing pump 46. Next, a predetermined amount of joint compound powder is slowly poured into hopper 26. Beater 40 is now caused to rotate so as to mix the water and powder together. If the joint compound appears to be too thick, an additional small volume of water is admitted to hopper 26 through nozzles 48. If the joint compound, however, appears to be too thin, an additional quantity of powder is added. When the joint compound in hopper has the correct consistency, it is ready to be applied to drywall.

Joint compound can be found with curing times that range from a few minutes to several hours. If a user is employing joint compound that sets up in fifteen minutes or less, not much time should be wasted in applying the material. Slow-setting joint compound can be induced to harden and thicken more rapidly with the application of heat form heater 36. Energizing heater 36 by rotating variable resistor knob 74 permits a user to tweak the viscosity and rate at which the joint compound will harden.

Seal 64 provided on lid 58 prevents the joint compound in hopper 26 from drying in the event that the user decides to take an extended break from work. To further ensure that the joint compound will not dry out, the joint compound can be “topped off” with the application of a water seal wherein a few inches of water are pumped through nozzles 48 onto the joint compound in hopper 26 and not mixed. The water seal ensures that the joint compound is not contacted by air and stays fresh. Once the joint compound is sealed by water, a user can leave it overnight or leave it for two weeks. When it is desired to use the joint compound, the water need only be drained and the joint compound remixed with beater 40.

After priming pump 24 as described hereinabove, joint compound is easily gotten from hopper 26 and delivered to roller 174 for application to drywall simply by squeezing control lever 158 of valve assembly 146 toward conduit 152. A small movement of lever 158 opens valve 156 a small amount thus resulting in a small flow of joint compound through extension arm 150 and applicator 16. A large movement of lever 158, however, opens valve 156 to a correspondingly greater degree thereby supplying a large flow of joint compound through extension arm 150 and applicator 16.

By grasping handle 256 of extension arm 150 in one hand and valve assembly 146 in the other hand, roller 174 can be positioned anywhere that a user may desire on a typical wall or ceiling. Simply by moving his hands, roller 174 can be driven along a wall or ceiling in any direction. Joint compound flow from roller 174 is minutely controlled by manipulating lever 158 and key 162 of valve 156. An entire wall or ceiling can be covered in minutes with joint compound driven by pump 24 into, and through, outer transverse leg 180, roller bearing 170, and roller 174. Old techniques, by way of contrast, required hours of labor.

When the user has finished applying joint compound to ceiling and wall surfaces of drywall, the tool can be easily disassembled and washed with soap and water. After tool 10 has dried, it can be stored in an out-of-the-way location. Tool 10 is always ready for immediate reuse.

While tool 10 has been described with a high degree of particularity, it will be appreciated by those skilled in the art that modifications can be made to it. Therefore, it is to be understood that the present invention is not limited to tool 10, but encompasses any and all tool embodiments within the scope of the following claims.

We claim:

1. A joint compound tool, comprising:
a mixer including:
a hopper having opposed ends and a hopper outlet being adjacent to one of said opposed ends;
a beater being positioned within said hopper, said beater having:
a rotatable drive shaft being journaled in said opposed ends of said hopper and having a longitudinal axis that extends between said opposed ends of said hopper;
a plurality of first support rods radiating outwardly from said drive shaft remote from said hopper outlet, each of said first support rods having a first inner end being affixed to said drive shaft and a first, outer, free end being remote from said drive shaft;
a pair of intertwined, helical bands encircling said drive shaft, said helical bands being affixed to said first, free ends of said first support rods;
a plurality of second support rods radiating outwardly from said drive shaft adjacent said hopper outlet, each of said second support rods having a second inner end being affixed to said drive shaft and a second, outer, free end being remote from said drive shaft;
a plurality of blades, each being secured to a respective one of said second, free ends of said second support rods, each of said blades being oriented at an angle of 45° to the longitudinal axis of said drive shaft with adjacent ones of said blades being oriented at an angle of 90° to one another;
a motor being connected to said drive shaft for rotating said beater; and,
a pump having a pump inlet being connected to said hopper outlet for receiving joint compound from of said hopper and, also, having a pump outlet for discharging joint compound received from said pump inlet;
a hose having first and second ends with said first end being releasably connected to said pump outlet for transporting joint compound away from said pump; and,
a joint compound applicator being releasably connected to said second end of said hose, said applicator including:
a valve assembly for controlling the flow of joint compound received from said hose; and,
a roller assembly for applying joint compound to drywall.

2. The joint compound tool according to claim 1 further comprising:
a water tank being suspended from said hopper;
a submersible pump being located within said water tank for delivering water in said water tank to said hopper; and,
a pair of spray nozzles being affixed to the top of said hopper and being connected to said submersible pump for delivering water received from said submersible pump into said hopper.

3. The joint compound tool according to claim 1 further comprising an electrical resistance heating element being positioned within said hopper for warming the contents thereof.

4. The joint compound tool according to claim 1 further comprising an extension arm releasably connecting said valve assembly to said roller assembly, said extension arm includes:
a rigid conduit for conveying pressurized joint compound from said valve assembly to said roller assembly; and,
a handle being affixed to said rigid conduit and projecting outwardly therefrom for manipulating said rigid conduit.

5. The joint compound tool according to claim 1 wherein said roller assembly further comprises:
a tubular staff having an inner end being releasably connected to said valve assembly and also having an outer end remote from said inner end, said staff being adapted to convey pressurized joint compound from said inner end to said outer end, said staff having a plurality of first slots therein for the passage of joint compound;
a roller bearing being rotatably secured to said outer end of said staff, said roller bearing having a plurality of second slots therein for the passage of joint compound received from said first slots; and,
a roller being fitted upon said roller bearing for dispensing joint compound to drywall, said roller bearing including:
a tubular former being formed of a rigid material and being snugly fitted over said roller bearing, said former having a plurality of third slots therein for the passage of joint compound received from said second slots; and,
a tubular sheath surrounding said former and being formed of a material that is resilient, porous and permeable to joint compound.

6. The joint compound tool according to claim 5 wherein said roller bearing has a pair of opposite sides and is provided with a pair of V-shaped notches extending the length of said opposite sides for channeling the flow of joint compound toward the middle of said roller bearing.

7. The joint compound tool according to claim 5 wherein said roller bearing further includes a tubular sleeve with external helical threads that receives said outer end of said staff therein and said joint compound tool further comprises a bearing retainer for rotatably fastening said roller bearing to said staff, said bearing retainer including:
a retaining collar being affixed to said staff and encircling said outer end of said staff so as to form a seal impervious to the passage of joint compound, said retaining collar being provided with a circumferential groove therein; and,
a bearing stop being rotatably fastened to said retaining collar, said bearing stop including:
a shoulder plate extending outwardly from said retaining collar and being snugly, yet rotatably, fitted within said circumferential groove of said retaining collar;
a pair of tabs being affixed to, and projecting from, one side of said shoulder plate; and,
a socket member extending from the side of said shoulder plate opposite said tabs, said socket member encircling said outer end of said staff and being provided with internal helical threads adapted for threaded engagement with said external helical threads of said roller bearing.
